(19) United States
(12) Patent Application Publication
(10) Pub. No.: US 2026/0106510 A1
(43) Pub. Date: Apr. 16, 2026

(54) ELECTROMECHANICAL UNIT

(71) Applicant: TOYOTA JIDOSHA KABUSHIKI KAISHA, Toyota-shi (JP)

(72) Inventors: Hiroshi HORISAKI, Toyota-shi (JP); Kohei SHIMAYABU, Nagakute-shi (JP)

(73) Assignee: TOYOTA JIDOSHA KABUSHIKI KAISHA, Toyota-shi (JP)

(21) Appl. No.: 19/330,222

(22) Filed: Sep. 16, 2025

(30) Foreign Application Priority Data
Oct. 16, 2024 (JP) 2024-180767

(51) Int. Cl. H02K 5/20; H02K 9/19; H02K 11/33; B60L 50/60

(52) U.S. Cl. CPC H02K 5/203; H02K 9/19; H02K 11/33; B60L 50/60

(57) ABSTRACT

An electromechanical unit for a vehicle may include: a housing including a first chamber and a second camber located above the first chamber; a motor located in the first chamber; an oil passage located in the first chamber and including a discharge opening for discharging oil to the motor from above the motor; an electrical circuit unit located in the second chamber; a cooler located in the second chamber and configured to cool the electrical circuit unit; and a branched cooling passage branched from a cooling passage for supplying a coolant to the cooler. At least a portion of the branched cooling passage may be located near the oil passage in the first chamber.

### CROSS REFERENCE TO RELATED APPLICATION

This application claims priority to Japanese Patent Application No. 2024-180767 filed on October 16, 2024. The entire content of the priority application is incorporated herein by reference.

### TECHNICAL FIELD

The art disclosed herein relates to an electromechanical unit for a vehicle.

### BACKGROUND ART

International Publication No. 2012/105353 describes an electromechanical unit for a vehicle that includes a housing having a first chamber and a second chamber, a motor located in the first chamber, an electrical circuit unit located in the second chamber, and a cooler for cooling the electrical circuit unit.

### SUMMARY

Some electromechanical units may further include an oil passage located above the motor. In such an electromechanical unit, the motor is cooled by lubricating oil being discharged from a discharge opening formed in the oil passage to the motor.

However, the oil passage located above the motor extends in an upper portion of the first chamber and is located near the second chamber in which the electrical circuit unit is located. Therefore, the temperature of the lubricating oil flowing through the oil passage may rise due to heat received from the electrical circuit unit, resulting in a decrease in the cooling efficiency for the motor. The disclosure herein provides a technology for suppressing a decrease in cooling efficiency for a motor in an electromechanical unit.

An electromechanical unit for a vehicle disclosed herein may comprise a housing comprising a first chamber and a second camber located above the first chamber; a motor located in the first chamber; an oil passage located in the first chamber and comprising a discharge opening for discharging oil to the motor from above the motor; an electrical circuit unit located in the second chamber; a cooler located in the second chamber and configured to cool the electrical circuit unit; and a branched cooling passage branched from a cooling passage for supplying a coolant to the cooler. At least a portion of the branched cooling passage may be located near the oil passage in the first chamber.

### BRIEF DESCRIPTION OF DRAWINGS

FIG. 1 is a diagram schematically illustrating a configuration of an electromechanical unit.

FIG. 2 is a top view of a motor, illustrating an example of arrangement of the motor, oil passage, and second cooling passage in a first chamber.

FIG. 3 is a diagram schematically illustrating a cross section along line III-III in FIG. 2.

FIG. 4 is a top view of a motor, illustrating an example of arrangement of the motor, oil passage, and second cooling passage in a first chamber.

FIG. 5 is a top view of a motor, illustrating an example of arrangement of the motor, oil passage, and second cooling passage in a first chamber.

### DETAILED DESCRIPTION

In one aspect of the present teachings, an electromechanical unit for a vehicle disclosed herein may comprise a housing comprising a first chamber and a second camber located above the first chamber; a motor located in the first chamber; an oil passage located in the first chamber and comprising a discharge opening for discharging oil to the motor from above the motor; an electrical circuit unit located in the second chamber; a cooler located in the second chamber and configured to cool the electrical circuit unit; and a branched cooling passage branched from a cooling passage for supplying a coolant to the cooler. At least a portion of the branched cooling passage may be located near the oil passage in the first chamber. Here, “near the oil passage” may include any positions where the temperature of oil flowing through the oil passage is lower when the branched cooling passage is in the first chamber, compared to when there is no branched cooling passage.

In the above electromechanical unit, the branched cooling passage is located near the oil passage in the first chamber. This allows for cooling of the oil flowing through the oil passage, thereby suppressing a decrease in cooling efficiency for the motor.

In one embodiment of the present teachings, at least the portion of the branched cooling passage may be located between the electrical circuit unit and the oil passage.

In one embodiment of the present teachings, at least the portion of the branched cooling passage may be in contact with the oil passage.

In one embodiment of the present teachings, the oil passage may extend above the motor along an axial direction of the motor. At least the portion of the branched cooling passage may be located near the oil passage and upstream of the discharge opening of the oil passage.

In one embodiment of the present teachings, the branched cooling passage may comprise a plurality of branched cooling passages. At least a portion of each of the plurality of branched cooling passages may be located near the oil passage.

In one embodiment of the present teachings, the branched cooling passage may comprise a parallel cooling passage extending in parallel to the oil passage. The parallel cooling passage may be located near the oil passage.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved electromechanical units, as well as methods for using and manufacturing the same.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Hereinbelow, an electromechanical unit 10 for a vehicle is described with reference to the drawings. The electromechanical unit 10 is mounted in a vehicle including a traction motor. Such a vehicle may be, but not limited to, for example, a hybrid vehicle, an electric vehicle, or a fuel vehicle. A part of or entirety of the teachings in this embodiment is also applicable to vehicles that run on tracks. The vehicle is not limited to those operated by users, but may comprise vehicles remotely operated by an external device or autonomous vehicles.

Here, directions of the electromechanical unit 10 in the drawings are the directions thereof when the electromechanical unit 10 is mounted on the vehicle, i.e., correspond to the directions of the vehicle. A direction FR indicates a front direction of the front-rear direction of the vehicle, and a direction RR indicates a rear direction of the front-rear direction of the vehicle. A direction LH indicates a left direction of the left-right direction of the vehicle, and a direction RH indicates a right direction of the left-right direction of the vehicle. A direction UP indicates an up direction of the up-down direction of the vehicle, and a direction DW indicates a down direction of the up-down direction of the vehicle.

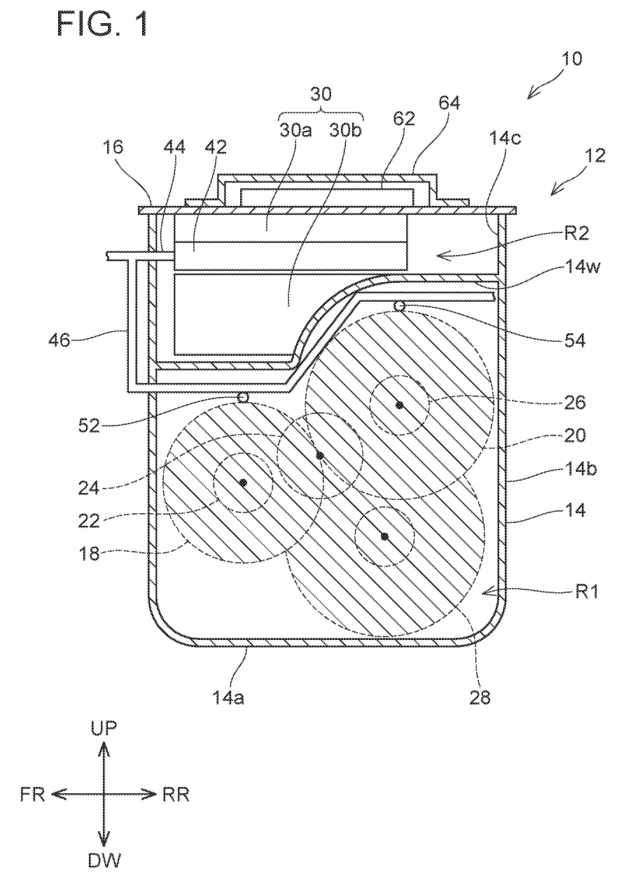

As shown in FIG. 1, the electromechanical unit 10 comprises a housing 12, which is an enclosure member. The housing 12 comprises a housing body 14 and a cover plate 16. The housing body 14 comprises a bottom wall 14a, a side wall 14b extending upward from the outer edge of the bottom wall 14a, and a partition wall 14w. An opening 14c is formed by the upper end of the side wall 14b in an upper portion of the housing body 14. The cover plate 16 is attached to the opening 14c of the housing body 14, and the opening 14c of the housing body 14 is closed by the cover plate 16. The partition wall 14w is located inside the housing 12 and partitions the interior of the housing 12 into a first chamber R1 and a second chamber R2. The second chamber R2 is located above the first chamber R1. The housing body 14 may be constituted of a metallic material, such as aluminum, although this need not always be the case. The cover plate 16 is a plate-shaped member and may be constituted of a metallic material such as aluminum, although this need not always be the case.

The electromechanical unit 10 further comprises a plurality of motors 18, 20 and a plurality of gear mechanisms 22, 24, 26, 28. The plurality of motors 18, 20 comprises a first motor 18 and a second motor 20. The first motor 18 and the second motor 20 are located in the first chamber R1. The second motor 20 may be located, for example, rearward of the first motor 18, although this need not always be the case. Further, at least a portion of the second motor 20 may be located, for example, above the first motor 18, although this need not always be the case. The plurality of gear mechanisms 22, 24, 26, 28 is located in the first chamber R1. The plurality of gear mechanisms 22, 24, 26, 28 comprises a planetary gear mechanism 22, a reduction gear mechanism 24, a motor output gear mechanism 26, and a differential gear mechanism 28. The motor output gear mechanism 26 is connected to the second motor 20 via an axle. Thus, the vehicle can transmit power from the second motor 20 to wheels via the motor output gear mechanism 26. The number of motors is not necessarily limited to two, but at least one. Similarly, the number of gear mechanisms is not necessarily be multiple, but at least one.

The electromechanical unit 10 further comprises an electrical circuit unit 30. The electrical circuit unit 30 is located in the second chamber R2. The electrical circuit unit 30 is also referred to as a PCU (power control unit) and is configured to convert power from a high-voltage battery installed in the vehicle from direct current to alternating current and supply it to the first motor 18 and the second motor 20. The electrical circuit unit 30 comprises a first electrical circuit unit 30a and a second electrical circuit unit 30b. The second electrical circuit unit 30b is located below the first electrical circuit unit 30a. The first electrical circuit unit 30a may be fixed, for example, to the cover plate 16 of the housing 12, although this need not always be the case. The second electrical circuit unit 30b may be fixed, for example, to the housing body 14, although this need not always be the case.

The first electrical circuit unit 30a may comprise, for example, a boost converter circuit and an inverter circuit, although this need not always be the case. The boost converter and inverter circuit comprise a plurality of switching elements. The plurality of switching elements is controlled by a control board 62 located on the upper surface of the cover plate 16 to convert the power from the high-voltage battery from direct current to alternating current. A protective cover 64 is located on the cover plate 16 to cover the control board 62.

The second electrical circuit unit 30b may comprise, for example, a reactor and a step-down converter, although this need not always be the case. The reactor is also a component constituting the boost converter circuit of the first electrical circuit unit 30a. The step-down converter is electrically connected between the high-voltage battery and an auxiliary battery and is configured to step down DC power from the high-voltage battery and supply it to the auxiliary battery. The auxiliary battery is connected to various control systems and other auxiliary equipment of the vehicle and supplies power to them.

The electromechanical unit 10 further comprises a cooler 42, a cooling passage 44, and a branched cooling passage 46. The cooler 42 is located in the second chamber R2. The cooler 42 recovers heat from the electrical circuit unit 30 to cool the electrical circuit unit 30. The cooler 42 is provided, for example, corresponding to the first electrical circuit unit 30a of the electrical circuit unit 30 and may be configured to cool the boost converter circuit and the inverter circuit of the first electrical circuit unit 30a, although this need not always be the case. Instead of this, the cooler 42 may be provided corresponding to the second electrical circuit unit 30b or may be provided corresponding to both the first electrical circuit unit 30a and the second electrical circuit unit 30b. The cooling passage 44 supplies a coolant (e.g., water) to the cooler 42. The cooling passage 44 is connected to a radiator and a coolant pump located outside the housing 12. When the coolant pump is activated, the coolant circulates between the cooler 42 and the radiator via the cooling passage 44.

The branched cooling passage 46 is branched from the cooling passage 44, extends through the first chamber R1, and returns to the cooling passage 44. The branched cooling passage 46 may be, for example, a part of the circulation passage formed by the cooling passage 44 that is connected in parallel to the cooler 42, although this need not always be the case. In this example, the bifurcations between the cooling passage 44 and the branched cooling passage 46 are located outside the housing body 14. Instead of this, the bifurcations between the cooling passage 44 and the branched cooling passage 46 may be located inside the housing body 14, for example, in the first chamber R1.

The electromechanical unit 10 further comprises a plurality of oil passages 52, 54. The plurality of oil passages 52, 54 comprises a first oil passage 52 and a second oil passage 54. The first oil passage 52 and the second oil passage 54 are located in the first chamber R1. The first oil passage 52 is located above the first motor 18 and discharges lubricating oil from its discharge openings to the first motor 18 to cool the first motor 18. The second oil passage 54 is located above the second motor 20 and discharges lubricating oil from its discharge openings to the second motor 20 to cool the second motor 20. The first oil passage 52 and the second oil passage 54 are connected to an oil cooler and an oil pump located outside the housing 12. When the oil pump is activated, the lubricating oil cooled by an oil cooler is supplied to the first oil passage 52 and the second oil passage 54.

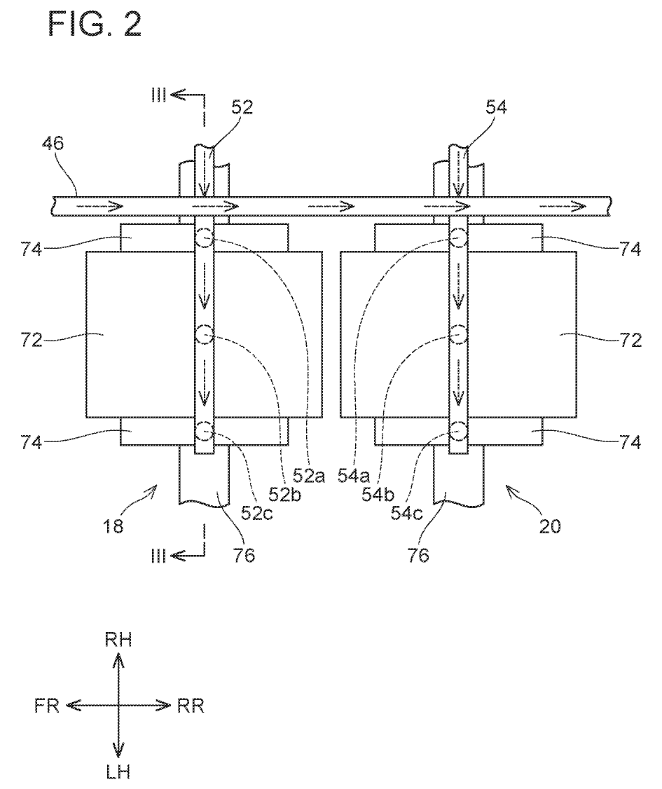

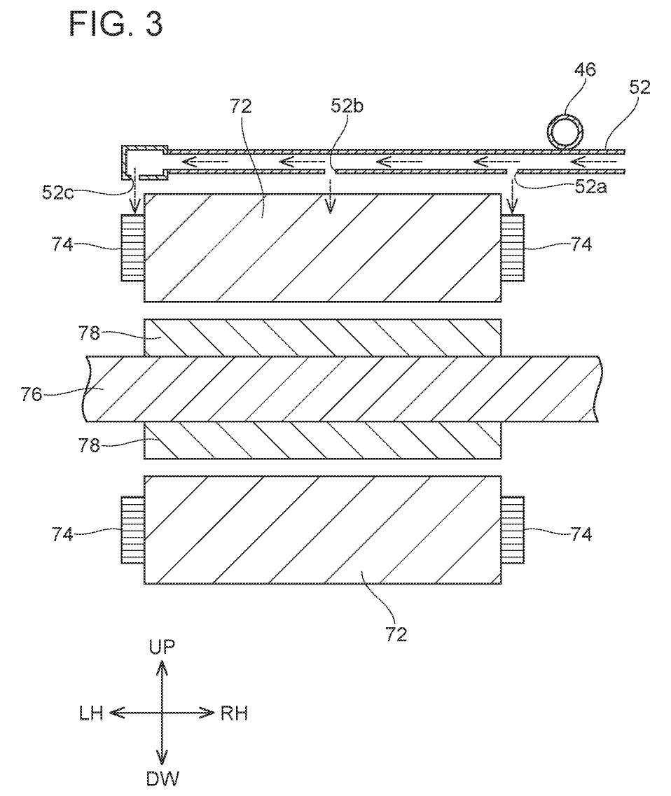

FIG. 2 shows a positional relationship between the plurality of motors 18 and 20, the plurality of oil passages 52, 54, and the branched cooling passage 46. FIG. 3 schematically shows the configurations of the first motor 18 and the first oil passage 52. The configurations of the second motor 20 and the second oil passage 54 are similar to those of the first motor 18 and the first oil passage 52, and thus the description thereon is omitted. Further, signs used for the second motor 20 and the second oil passage 54 and signs used for the first motor 18 and the first oil passage 52 are given according to the same scheme. The dashed arrows in the drawings indicate flows of the coolant in the branched cooling passage 46 and the lubricating oil in the plurality of oil passages 52, 54.

The first motor 18 comprises a stator core 72, a stator coil 74, a central shaft 76, and a rotor 78. The stator core 72 has an axially extending cylindrical structure and is formed of a stack of multiple electromagnetic steel plates. The stator coil 74 is a collectivity of coil wires that constitute a plurality of coils. Each of the coils is wound around a corresponding one of teeth formed on the inner circumferential surface of the stator core 72. Both axial ends of the stator coil 74 protrude from the stator core 72 and are specifically referred to as coil ends. The rotor 78 is fixed to the central shaft 76 and is formed of a stack of electromagnetic steel plates. The central shaft 76 and the rotor 78 are located within the central hole of the stator core 72 and are supported to be rotatable about the axis of the first motor 18.

The first oil passage 52 is a conduit for discharging lubricating oil to the first motor 18. The first oil passage 52 extends above the first motor 18 along the axial direction of the first motor 18. In this example, one first oil passage 52 is provided for the first motor 18. Instead of this, multiple oil passages extending along the axial direction of the first motor 18 may be arranged spaced apart from each other in the circumferential direction of the first motor 18.

The first oil passage 52 has a plurality of discharge openings 52a, 52b, 52c. The plurality of discharge openings 52a, 52b, 52c comprises a first discharge opening 52a, a second discharge opening 52b, and a third discharge opening 52c. The first discharge opening 52a is the most upstream discharge opening among the plurality of discharge openings 52a, 52b, and 52c, and is positioned such that the lubricating oil is supplied therethrough toward one coil end of the stator coil 74. The third discharge opening 52c is the most downstream discharge opening among the plurality of discharge openings 52a, 52b, and 52c, and is positioned such that the lubricating oil is supplied therethrough toward the other coil end of the stator coil 74. The second discharge port 52b is located between the first discharge port 52a and the third discharge port 52c, and is positioned such that the lubricating oil is supplied therethrough toward the stator core 72. The number and positions of the discharge openings formed in the first oil passage 52 are not particularly limited, and may be modified in various ways to cool the first motor 18.

As shown in FIGS. 1 and 2, the branched cooling passage 46 extends near each of the first oil passage 52 and the second oil passage 54 in the first chamber R1. In this example, the branched cooling passage 46 extends in a direction (in the front-rear direction of the vehicle) perpendicular to the extending direction of the oil passages 52, 54 (the left-right direction of the vehicle). The branched cooling passage 46 extends above the plurality of oil passages 52, 54, i.e., between the partition wall 14w of the housing body 14 and the plurality of oil passages 52, 54. In this example, the branched cooling passage 46 is in contact with the surfaces of the oil passages 52, 54. The branched cooling passage 46 is in contact with a portion of the first oil passage 52 that is upstream of the most upstream first discharge opening 52a of the first oil passage 52 and is in contact with a portion of the second oil passage 54 that is upstream of the most upstream first discharge opening 54a of the second oil passage 54. The branched cooling passage 46 and the plurality of oil passages 52, 54 may be constituted of a metallic material such as aluminum and may be formed integrally.

The plurality of oil passages 52, 54 located above the plurality of motors 18, 20 extend in an upper portion of the first chamber R1. Heat radiated from the electrical circuit unit 30 in the second chamber R2 is transferred to the upper portion of the first chamber R1. Therefore, the temperature of the lubricating oil flowing through the plurality of oil passages 52, 54 may rise due to the heat received from the electrical circuit unit 30, resulting in a decrease in the cooling efficiency for the plurality of motors 18, 20.

In this embodiment, the branched cooling passage 46 is located near the plurality of oil passages 52, 54 in the first chamber R1. This cools the lubricating oil flowing through the plurality of oil passages 52, 54, thereby suppressing a decrease in the cooling efficiency for the plurality of motors 18, 20.

The branched cooling passage 46 is located between the electrical circuit unit 30 and the plurality of oil passages 52, 54. Thus, the branched cooling passage 46 can suppress heat transfer from the electrical circuit unit 30 to the plurality of oil passages 52, 54. In addition, the branched cooling passage 46 is in contact with the oil passages 52, 54. This allows for efficient cooling of the lubricating oil flowing through the plurality of oil passages 52, 54.

Furthermore, the branched cooling passage 46 is in contact with the portions of oil passages 52, 54 that are upstream of the most upstream first discharge openings 52a, 54a of the oil passages 52, 54. This allows the lubricating oil to be cooled before it is discharged to the plurality of motors 18, 20, thereby suppressing a decrease in the cooling efficiency for the plurality of motors 18, 20.

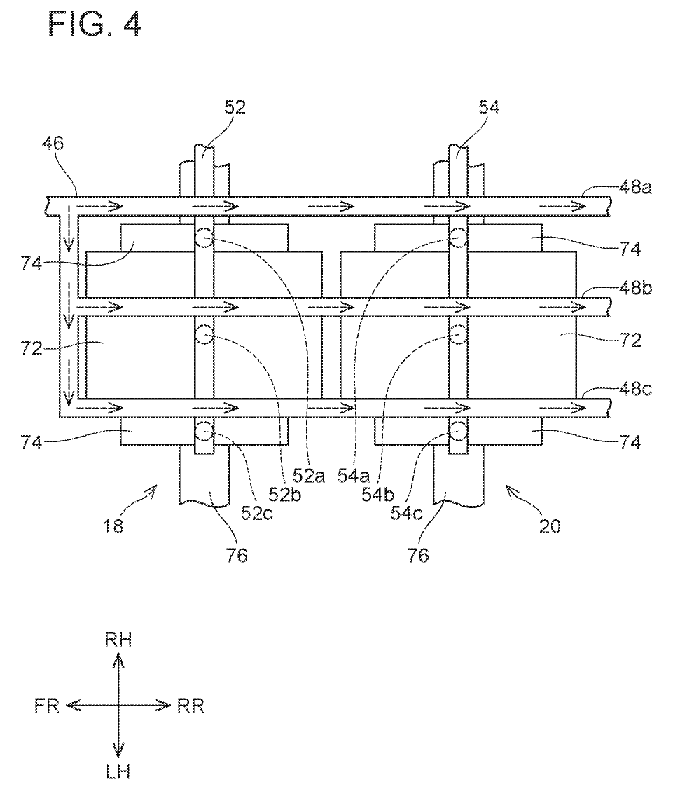

As shown in FIG. 4, the branched cooling passage 46 may comprise a plurality of branched cooling passages 48a, 48b, 48c. The plurality of branched cooling passages 48a, 48b, 48c are re-branched from the branched cooling passage 46 and comprises a first branched cooling passage 48a, a second branched cooling passage 48b, and a third branched cooling passage 48c. In this example, the branched cooling passages 48a, 48b, 48c extend parallel to each other. Instead of this, at least one of the branched cooling passages 48a, 48b, 48c may extend non-parallel to the other passage(s). The first branched cooling passage 48a, the second branched cooling passage 48b, and the third branched cooling passage 48c are arranged in this order from upstream to downstream of the plurality of oil passages 52, 54.

The first branched cooling passage 48a is in contact with each of the plurality of oil passages 52, 54 at their portions upstream of the first discharge openings 52a, 54a of the oil passages 52, 54. The second branched cooling passage 48b is in contact with each of the plurality of oil passages 52, 54 between the first discharge openings 52a, 54a and the second discharge openings 52b, 54b of the oil passages 52, 54. The third branched cooling passage 48c is in contact with each of the plurality of oil passages 52, 54 between the second discharge openings 52b, 54b and the third discharge openings 52c, 54c of the oil passages 52, 54. Thus, the number of branched cooling passages 48a, 48b, 48c may be the same as the number of discharge openings formed in each of the oil passages 52, 54. In this embodiment, an area of the branched cooling passage 46 that is located near the plurality of oil passages 52, 54 is larger, so that the lubricating oil flowing through the oil passages 52, 54 can be efficiently cooled.

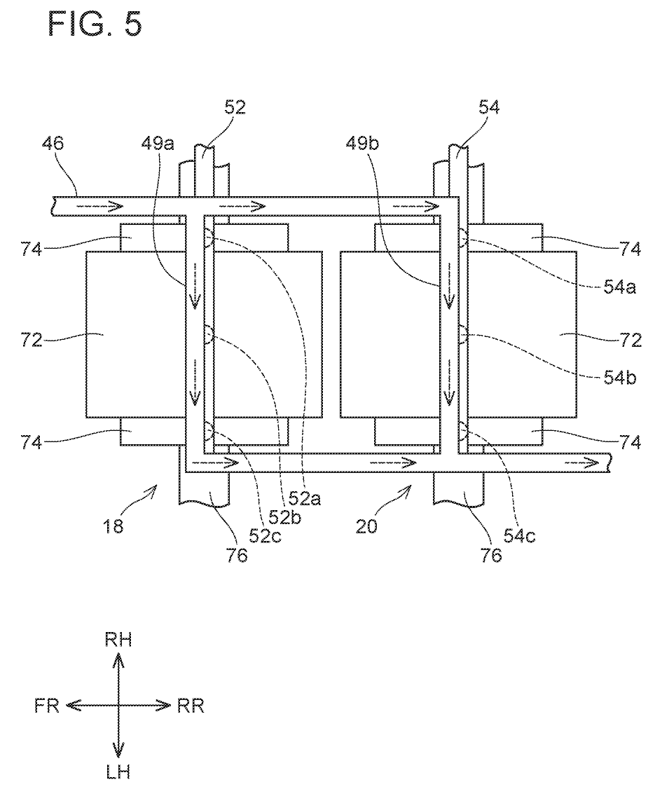

As shown in FIG. 5, the branched cooling passage 46 may comprise a plurality of parallel cooling passages 49a, 49b. The parallel cooling passages 49a, 49b are re-branched from the branched cooling passage 46 and comprise a first parallel cooling passage 49a and a second parallel cooling passage 49b. The first parallel cooling passage 49a extends parallel to the first oil passage 52 and is in contact with the first oil passage 52 at least from a position upstream of the first discharge opening 52a to the position of the third discharge opening 52c. When viewed from above the first motor 18, the first parallel cooling passage 49a may overlap the first oil passage 52 so that the first oil passage 52 is hidden. The second parallel cooling passage 49b extends parallel to the second oil passage 54 and is in contact with the second oil passage 54 at least from a position upstream of the first discharge opening 54a to the position of the third discharge opening 54c. When viewed from above the second motor 20, the second parallel cooling passage 49b may overlap the second oil passage 54 so that the second oil passage 54 is hidden. In this embodiment, an area of the branched cooling passage 46 that is located near the oil passages 52, 54 is larger, allowing for efficient cooling of the lubricating oil flowing through the oil passages 52, 54.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. An electromechanical unit for a vehicle, comprising:
a housing comprising a first chamber and a second camber located above the first chamber;
a motor located in the first chamber;
an oil passage located in the first chamber and comprising a discharge opening for discharging oil to the motor from above the motor;
an electrical circuit unit located in the second chamber;
a cooler located in the second chamber and configured to cool the electrical circuit unit; and
a branched cooling passage branched from a cooling passage for supplying a coolant to the cooler,
wherein at least a portion of the branched cooling passage is located near the oil passage in the first chamber.

2. The electromechanical unit according to claim 1, wherein at least the portion of the branched cooling passage is located between the electrical circuit unit and the oil passage.

3. The electromechanical unit according to claim 1, wherein at least the portion of the branched cooling passage is in contact with the oil passage.

4. The electromechanical unit according to claim 1, wherein
the oil passage extends above the motor along an axial direction of the motor, and
at least the portion of the branched cooling passage is located near the oil passage and upstream of the discharge opening of the oil passage.

5. The electromechanical unit according to claim 1, wherein
the branched cooling passage comprises a plurality of branched cooling passages, and
at least a portion of each of the plurality of branched cooling passages is located near the oil passage.

6. The electromechanical unit according to claim 1, wherein
the branched cooling passage comprises a parallel cooling passage extending in parallel to the oil passage, and
the parallel cooling passage is located near the oil passage.
